(19) United States
(12) Patent Application Publication
(10) Pub. No.: US 2023/0062591 A1
(43) Pub. Date: Mar. 2, 2023

(54) METHOD FOR ESTIMATING SERVICE VALUE SPACES OF WETLAND ECOSYSTEMS

(71) Applicant: QINGHAI NORMAL UNIVERSITY, XINING (CN)

(72) Inventors: XUFENG MAO, XINING (CN); XIAOYAN WEI, XINING (CN); XIUHUA SONG, XINING (CN); XIN JIN, XINING (CN); WENJIA TANG, XINING (CN); HONGYAN YU, XINING (CN); YANFANG DENG, XINING (CN); JIAN HU, XINING (CN); WENYING WANG, XINING (CN); HUAKUN ZHOU, XINING (CN)

(21) Appl. No.: 17/874,289

(22) Filed: Jul. 27, 2022

(30) Foreign Application Priority Data
Aug. 19, 2021 (CN) 2021109563172

(51) Int. Cl. G06Q 30/02; G06Q 50/16

(52) U.S. Cl. CPC G06Q 30/0206; G06Q 50/165

(57) ABSTRACT

A method for estimating service value spaces of wetland ecosystems includes steps of: calculating service values of wetland ecosystems through a hedonic pricing method; and calculating, based on the service values of the wetland ecosystems, a spatial distribution state of the service values of the wetland ecosystems through a breaking point theory and a weighted Voronoi diagram model, and outputting the spatial distribution state.

### TECHNICAL FIELD

The invention relates to the field of wetland value research, and in particularly to a method for estimating service value spaces of wetland ecosystems.

### BACKGROUND

Wetlands can provide many ecosystem services, such as purifying air, beautifying the environment and purifying water sources, for surrounding residents. The services value evaluation of wetland ecosystem is an important basis for wetland management and related decision-making, which is beneficial to wetland protection, restoration and sustainable utilization.

Since Constaza carried out the value evaluation of the global ecosystem in 2007, many domestic and foreign scholars have made extensive and in-depth evaluations on the supply, support, adjustment and cultural services of wetland. The researches have promoted the progress of services evaluation system and method of wetland ecosystem. Based on existing research results, it is found that a wetland value calculated based on the current evaluation system and method is very large, but the calculated value cannot be transformed into a real market value. For example, when using one-dimensional and two-dimensional models of water purification capacity to calculate a water purification function of a wetland, a calculation result is an “opportunity cost” of wetland purification value, which is an ideal state that has not been “admitted” by the market, and thus its value has not been truly reflected in the market price.

In order to solve the above problem, different scholars have carried out researches on service values of wetland ecosystems based on hedonic pricing method. The value of wetland is “stripped” from the price of real estate, and then a real “market value” of wetland is calculated. Many studies have shown that people are willing to pay higher prices for residential neighbourhoods around a wetland, and values of residential neighbourhoods around the wetland can reflect real market values of wetland ecosystem services. However, a change of value of wetland ecosystem along with distance and value spatial distribution are not clear, and main factors affecting the wetland value also are not clear, and therefore it is urgent to find out key spatial processes and factors of service value of wetland ecosystem through an appropriate research method.

### SUMMARY

Embodiments of the invention provide a method for estimating service value spaces of wetland ecosystems, which can objectively calculate a spatial distribution state of service values of wetland ecosystems.

Specifically, a method for estimating service value spaces of wetland ecosystems, may include:

step 1, calculating service values of wetland ecosystems through a hedonic pricing method; and

step 2, calculating, based on the service values of the wetland ecosystems, a spatial distribution state of the service values of the wetland ecosystems through a breaking point theory and a weighted Voronoi diagram model, and outputting the spatial distribution state as a basis for wetland management.

In an embodiment, the method may further include:

step 3, calculating, based on the service values of the wetland ecosystems, influencing factors of the service values of the wetland ecosystems through a structural equation model, and outputting the influencing factors as a basis for wetland management.

It can be seen from the technical solutions provided by the above embodiments of the invention that: in the embodiments of the invention, the wetland ecosystem service value evaluation/estimation can provide important basis and dependence for wetland management and related decisions, and is beneficial to wetland protection, restoration, and sustainable utilization.

Additional aspects and advantages of the invention will be given in part in the following description, some of which will become apparent from the following description, or will be known through the practice of the invention.

### BRIEF DESCRIPTION OF THE DRAWINGS

In order to illustrate technical solutions of embodiments of the invention more clearly, drawings used in description of the embodiments will be briefly introduced below. Apparently, the drawings described below are only some of embodiments of the invention, and for those skilled in the art, other drawings can be obtained according to these drawings without any creative work.

FIG. 1 illustrates a schematic diagram of a method for estimating service value spaces of wetland ecosystems according to the invention.

FIG. 2 illustrates a schematic diagram of spatial distribution of service value of the Huangshui wetland ecosystem in an application scenario according to the invention.

FIG. 3 illustrates a schematic path diagram of model standardized coefficients in an application scenario according to the invention.

### DETAILED DESCRIPTION OF EMBODIMENTS

Embodiments of the invention will be described in detail below, examples of which are illustrated in the accompanying drawings, where the same or like reference numerals indicate the same or like elements or elements having the same or similar functions throughout. The embodiments described below with reference to the accompanying drawings are illustrative and intended only to explain the invention and are not to be construed as limiting the invention.

In order to facilitate the understanding of the embodiments of the invention, several specific embodiments are taken as examples to make further explanations with reference to the drawings, and the various examples do not constitute limitation to embodiments of the invention.

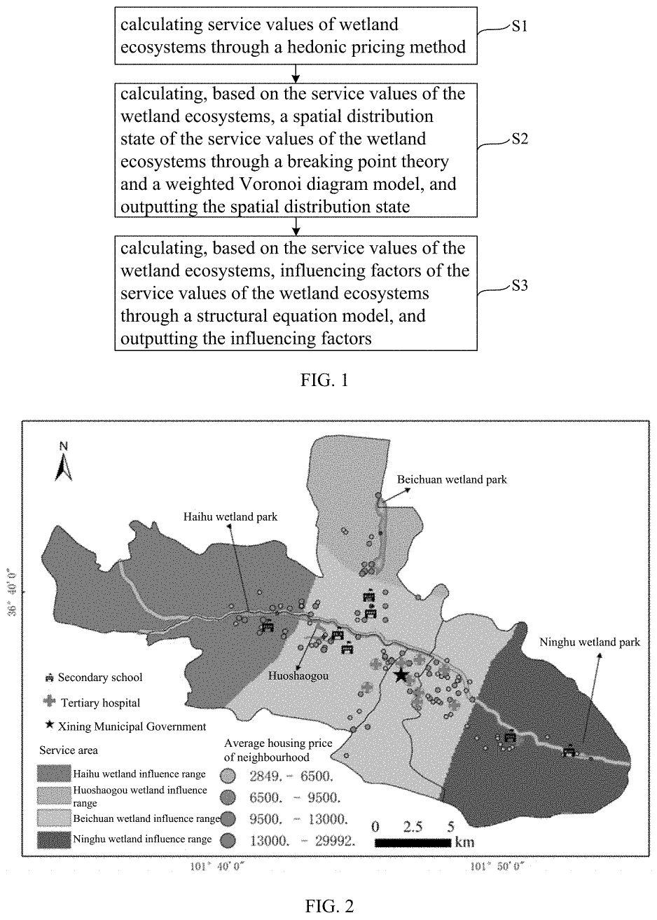

As illustrated in FIG. 1, a method for estimating service value spaces of wetland ecosystems according to the invention may include:

step S1, calculating service values of wetland ecosystems through a hedonic pricing method; and

step S2, calculating, based on the service values of the wetland ecosystems, a spatial distribution state of the service values of the wetland ecosystems through a breaking point theory and a weighted Voronoi diagram model, and outputting the spatial distribution state.

Moreover, the method may further include:

step S3, calculating, based on the service values of the wetland ecosystems, influencing factors of the service values of the wetland ecosystems through a structural equation model, and outputting the influencing factors.

In some embodiments of the invention, wetlands provide many ecosystem services, such as purifying air, beautifying the environment and purifying water sources, for surrounding residents. The evaluation of service values of wetland ecosystems is an important basis for wetland management and related decision-making, which is beneficial to wetland protection, restoration and sustainable utilization.

In an embodiment, the step S1 includes:

step 11, categorizing, based on distances between neighbourhoods in a designated area and the wetland ecosystems, the neighbourhoods into the wetland ecosystems, to establish a correspondence between the neighbourhoods and the wetland ecosystems;

step 12, multiplying an average transaction price of neighbourhoods of each of the wetland ecosystems by a transaction house quantity of each of the neighbourhoods of each of the wetland ecosystems, to obtain a transaction value of each of the neighbourhoods;

step 13, summing the transaction values of the neighbourhoods of each of the wetland ecosystems, to generate a transaction value of each of the wetland ecosystems;

step 14, generating a wetland coefficient for distance to wetland park of each of the neighbourhoods through the hedonic pricing method;

step 15, multiplying a total housing price of each of the wetland ecosystems by the wetland coefficient for distance to wetland park of each of the neighbourhoods and then being divided by a distance to wetland park of each of the neighbourhoods, to generate a marginal implicit price of each of the wetland ecosystems;

step 16, obtaining an average marginal implicit price of the wetland ecosystems based on the marginal implicit price of each of the wetland ecosystems;

step 17, dividing the average marginal implicit price of the wetland ecosystems by an average transaction price of the neighbourhoods of the wetland ecosystems, to obtain a marginal willingness to pay; and

step 18, multiplying the generated transaction value of each of the ecosystems by the marginal willingness to pay, to generate the service values of each of wetland ecosystems.

In an embodiment, the step 14 includes:

In(Pᵢ)=β₀+β₁Sᵢ+β₂Nᵢ+β₃Qᵢ+εᵢ

where, Pᵢ represents an average unit price of a i-th neighbourhood, Sᵢ represents a structural attribute characteristic vector matrix of housing, including transaction area, total construction area, greening rate, plot ratio, parking ratio, and property management fee of housing;

Nᵢ represents a neighborhood attribute characteristic vector matrix of housing, including distances of housing to its nearest middle school (secondary school), hospital and city center;

Qᵢ is a virtual variable introduced by model, and Qᵢ represents a distance to wetland park of the i-th neighbourhood;

βₖ represents a matrix of wetland coefficient for distance to wetland park of each of the neighbourhoods, and k=0, 1, 2, 3.

In an embodiment, the step S2 includes:

step 21, according to the breaking point theory, generating, based on the service values of the wetland ecosystems, weight data of each of the neighbourhoods with respect to the wetland ecosystem corresponding thereto through the weighted Voronoi diagram model;

step 22, generating a wetland center of each of the wetland ecosystems through an ArcGIS™ software (i.e., one kind of geographic information system platform software); and

step 23, generating a weighted Voronoi diagram of influencing ranges of the service values of the wetland ecosystems through a Thiessen polygon tool of the ArcGIS™ software based on the wetland center and the weight data, as the spatial distribution state of the service values of the wetland ecosystems.

In an embodiment, the step 23 includes:

$${V}_{n} ( {P}_{i} , {λ}_{i} ) = {⋂}_{j \neq i} \{ P \vert \frac{d ( P , {P}_{i} )}{{λ}_{i}} < \frac{d ( P , {P}_{j} )}{{λ}_{j}} \} , ( i = 1 , 2 , … , n )$$

where, Pᵢ represents n points on a two-dimensional Euclidean space, λᵢ represents given n positive real numbers; a plane is divided into n parts, division of the plane determined by Vₙ (Pᵢ, λᵢ) is called as a point-weighted Voronoi diagram, and λᵢ is the weight data of Pᵢ.

In an embodiment, the step S3 includes:

step 31, establishing the structural equation model based on potential variables of service types provided by the wetland ecosystems through a AMOS™ software (i.e., one kind of structural equation modeling software), to obtain standardized path coefficients of the service types;

step 32, dividing the standardized path coefficients of the service types by the sum of the standardized path coefficients of the service types, to generate an influencing coefficient of standardized path of each of services; and

step 33, multiplying the service value of each of the wetland ecosystems by the influencing coefficient of standardized path of each of the services, to obtain a service value of each of the services.

In an embodiment, the service types include: supply service, adjustment service, cultural service, and support service.

In an embodiment, the structural equation model specifically is:

X=Λₓξ+δ

Y=Λ_{y}η+ε

where, ξ represents an exogenous potential variable matrix, X represents a measurement variable matrix of ξ, Λₓ represents a measurement coefficient matrix of a relationship between the measurement variable matrix X and the exogenous potential variable matrix ξ, δ represents an equation residual matrix, Y represents a measurement variable matrix of η, Λ_{y} represents a measurement coefficient matrix of a relationship between an endogenous potential variable matrix η and Y, and ε represents another equation residual matrix.

In an embodiment, a formula of a structural model is:

η=Bη+Γξ+ζ

where, represents an exogenous potential variable, η represents an endogenous potential variable, B represents an endogenous potential variable coefficient matrix, Γ represents an exogenous potential variable coefficient matrix, and ζ represents residual of equation.

An application scenario of the invention will be described below. The invention provides a method for estimating service value spaces and influencing factors of wetland ecosystems based on a hedonic pricing model. Wetlands can provide enormous ecosystem services for urban development, but their real economic values are difficult to accurately assess. This research takes an urban wetland in Xining city, Qinghai province in China as an example, selects 10 factors including housing structure, accessibility, environment and wetland, uses a hedonic pricing model to analyze factor data (year 2020) of 110 neighbourhood samples around wetlands, and quantitatively analyzes influencing of urban wetland on housing price in Xining city. Moreover, based on GIS 10.2, ENVI 5.3 and other spatial analysis and questionnaire survey methods, the breaking point theory and the weighted Voronoi diagram model are used to analyze spatial influencing ranges of service values of wetland ecosystems. In addition, a structural equation model of influencing factors of service values of wetland ecosystems is constructed, and significant factors and their paths of affecting service values of wetland ecosystems are explored. The results show that: (1) a total value of Huangshui wetland reaches 336.7 million yuan in 2020, and an average service value of ecosystems is 151.916 yuan/m²; and service values of ecosystems ranked from large to small are that: Haihu wetland park (71 million yuan)>Ninghai wetland park (62.9 million yuan)>Huoshaogou wetland park (163.2 million yuan)>Beichuan wetland park (33 million yuan); (2) the service values of wetland ecosystems accounted for 2.04% of a total value of real estate, ranking seventh among the 10 factors; and a result of linear function model shows that the buyer's marginal willingness to pay for wetland is 0.12 (yuan/m²)m⁻¹, that is, the buyer is willing to additionally pay 0.12 yuan for every 1 in reduction in the distance between the house and the wetland; and (3) Buyers have the greatest willingness to pay for the cultural service in wetland ecosystem services.

Based on the existing research results, it is found that a wetland value calculated based on the current evaluation system and method is very large, but the calculated value cannot be transformed into a real market value. For example, when using one-dimensional and two-dimensional models of water purification capacity to calculate a water purification function of a wetland, a calculation result is an “opportunity cost” of wetland purification value, which is an ideal state that has not been “admitted” by the market, and thus its value has not been truly reflected in the market price.

An embodiment of the invention takes the Huangshui national wetland park in Xining city of China as an example, service values of ecosystems of the Huangshui national wetland park in 2020 is measured, and various wetland services are transformed into “housing price” factors recognized by the market, which has more authenticity and guiding value.

### 1. Overview of the Researched Area

The Huangshui national wetland park is located in the urban area of Xining city, Qinghai province in China, and its distribution range is 36°33′41″-36°44′42″ N, 101°37′06″-101°54′50″ E. The Xining city is located in the east of Qinghai province and the middle of Hehuang valley, with an average elevation of about 2261 m. The terrain is high in the northwest and low in the southeast. It belongs to the semi-arid climate zone of the plateau cold temperate zone, with low air pressure, long sunshine and large temperature difference between day and night. The annual average temperature is 5.8° C., and the annual average precipitation is 380 mm. The Huangshui river is the largest tributary in the upper reaches of the Yellow River, with a total length of 374 kin and a drainage area of more than 3200 km′. With the construction of Huangshui national wetland park, the ecosystem service function along the Huangshui River has become increasingly prominent. The Huangshui national wetland park is built along the Huangshui River and its first-class tributary Beichuan River, running through the city center of Xining, with a total area of 508.7 hectares.

(1) The Haihu wetland park is located in the west of the city (36°38′57″-36°39′29″ N, 101°40′24″-101°43′24″ E), and it is distributed on both sides of the north and south banks of Huangshui River, mainly extending in the east-west direction; the north and south banks of the wetland park are also full of residential areas, and the wetland park on the north bank is connected on both sides of Meilishui Street. (2) Huoshaogou wetland park is located in the west of the city (36°38′15″-36°39′01″ N, 101°42′40″-101°43′55″ E), due to the downstream urban river stepped dam landscape, purchase intentions of buyers for residential areas near Huoshaogou park are further enhanced. (3) Beichuan wetland park is located in the north of the city (36°40′40″-36°43′32″ N, 101°45′41″-101°46′11″ E), the Beichuan wetland park is the largest wetland park in Xining city, with water and green scenery accounting for more than 70% of the total area of the wetland park, it has six lakes and five parks, and it is very beneficial to improve the arid climate of residential areas around wetlands. (4) Ninghu wetland park is located on the north and south sides of Huangshui River (36°34′12″-36°33′48″ N, 101°52′43″-101°54′27″ E) in the eastern part of the city, it is an artificial wetland and a landscape wetland ecosystem with dual functions of water purification and biodiversity, and it is covered with reeds, Typha orientalis Presl, and other plants, and has high ornamental value.

### 2. Research Methods and Data Sources

1, Hedonic Pricing Method

A mathematical expression of the hedonic pricing model is: P=P(Z1, Z2, Z3, . . . , Zn), where P is the housing price, and Z1, Z2, Z3, . . . , Zn are housing price influencing factors (such as housing structure, neighborhood environment around the housing, etc.). This embodiment selects 10 variables being factors of influencing the housing price in Xining (Table 1).

Before using ArcGIS™ to regress the data, the Pearson correlation test is carried out on the variables, and the selection of variables is adjusted to prevent serious collinearity problems between variables. For example, there is a serious collinearity problem between the total construction area and the supply area, the quantity of supplied houses, so that the supply area and the quantity of supplied houses are excluded. Based on the hedonic pricing method, the price of residential housing is determined by values of various attribute characteristics of real estate. In order to obtain an accurate regression result, function models of linear form and linear logarithmic form are used in this embodiment:

Pᵢ=β₀+β₁Sᵢ+β₂Nᵢ+β₃Qᵢ+εᵢ (1)

In(Pᵢ)=β₀+β₁Sᵢ+β₂Nᵢ+β₃Qᵢ+εᵢ (2)

where, Pᵢ represents an average unit price of a i-th residential neighbourhood; Sᵢ represents a structural attribute characteristic vector matrix of housing, mainly including transaction area, total construction area, greening rate, plot ratio, parking ratio and property management fee of housing; Nᵢ represents a neighborhood attribute characteristic vector matrix of housing, mainly including distances between the housing and its nearest middle school, hospital, and city center; Qᵢ is a virtual variable introduced by the model, when Qᵢ represents the distance between the i-th residential neighbourhood and a wetland park, εᵢ is an error term, βᵢ (i=0, 1, 2, 3) represents a corresponding coefficient matrix. In order to further test the regression effect of the models, when performing F-test on the models, it is found that the models pass the F-test (F=8.479, P<0.05).

TABLE 1
Statistics of main variables

| | Characteristic | |
|---|---|---|
| | variable | Quantization basis |
| Location | Haihu wetland | Linear distance between |
| characteristic | park distance (m) | neighbourhood and Haihu |
| of | | wetland park (m) |
| neighbourhood | Beichuan wetland | Linear distance between |
| | park distance (m) | neighbourhood and Beichuan |
| | | wetland park (m) |
| | Huoshaogou wetland | Linear distance between |
| | park distance (m) | neighbourhood and Huoshaogou |
| | | wetland park (m) |
| | Ninghu wetland | Linear distance between |
| | park distance (m) | neighbourhood and Ninghu |
| | | wetland park (m) |
| Neighborhood | Nearest hospital | Linear distance between |
| characteristics | distance (m) | neighbourhood and the |
| | | nearest hospital (m) |
| | City center | Linear distance between |
| | distance (m) | neighbourhood and the |
| | | city center (m) |
| | Nearest middle | Linear distance between |
| | school distance (m) | neighbourhood and the |
| | | nearest middle school (m) |
| Attribute | Transaction area (m²) | |
| characteristics | Average transaction | |
| | price (Yuan/m²) | |
| | Total construction | |
| | area (m²) | |
| | Greening rate (%) | |
| | Plot ratio (%) | |
| | Parking ratio | |
| | Property management | |
| | fee (Yuan/m² · month) | |

2, Breaking Point Theory and Weighted Voronoi Diagram Model

In order to analyze the influencing range of wetland value, the breaking point theory and the weighted Voronoi diagram model are used to study a spatial range of wetland value. In 1949, based on Reilly's “retail gravity law”, Converse puts forward the breaking point theory. Action boundaries of ecosystem services of different wetland parks are quantitatively calculated through the breaking point model. A breaking point formula is as follows:

$${D}_{i} = \frac{{D}_{ij}}{1 + \sqrt{{P}_{j} / {P}_{i}}} \qquad ( 3 )$$

where, Dᵢ is a distance from wetland park i to a breaking point, Dᵢⱼ is a distance between a center of wetland park j and a center of wetland park i, Pᵢ and Pⱼ are ecosystem values of wetland park i and wetland park j, respectively. Based on the ecosystem service value method, the ecosystem service values of various wetland parks are obtained to substitute the ecosystem values. Using the Euclidean distance, Dᵢⱼ=Dⱼᵢ, the formula (3) is transformed into that:

$$\frac{{D}_{i}}{{D}_{j}} = \sqrt{\frac{{P}_{i}}{{P}_{j}}} \qquad ( 4 )$$

From the formula (4), it can be seen that the distances from two adjacent wetland parks to their breaking point are directly proportional to the square root of the ecosystem service values of the two wetland parks. Letting α₁ and α₂ to be expansion velocities of two adjacent growth nuclei belonging to the same homogeneous plane domain, and the time for α₁ and α₂ to expand to the breaking point at the same time is T, then D₁=α₁T, D₂=α₂T, which are substituted into the formula (4), a formula (5) as follow can be obtained.

$$\frac{{a}_{1}}{{a}_{2}} = \sqrt{\frac{{V}_{i}}{{V}_{j}}} \qquad ( 5 )$$

Supposing there are two wetland patches a(x₁, y₁) and b(x₂, y₂) in the researched area, and their ecosystem service values are Pₐ and P_{b} respectively. A coordinate of any point on boundaries of ranges of a, b is P(x, y). Based on the distance formula between two points, when Pₐ≠P_{b}, the formula (4) can be simplified as that:

$${( x - \frac{{P}_{b} {x}_{1} - {P}_{a} {x}_{2}}{{P}_{b} - {P}_{a}} )}^{2} + {( y - \frac{{P}_{b} {y}_{1} - {P}_{a} {y}_{2}}{{P}_{b} - {P}_{a}} )}^{2} = {( \frac{\sqrt{{P}_{a} {P}_{b}}}{{P}_{b} - {P}_{a}} {D}_{ab} )}^{2} \qquad ( 6 )$$

This equation is the equation of a circle, whose center is

$$( \frac{{P}_{b} {x}_{1} - {P}_{a} {x}_{2}}{{P}_{b} - {P}_{a}} , \frac{{P}_{b} {y}_{1} - {P}_{a} {y}_{2}}{{P}_{b} - {P}_{a}} ) ,$$

and whose radius is

$$\frac{\sqrt{{P}_{a} {P}_{b}}}{{P}_{b} - {P}_{a}} {D}_{ab} .$$

When the Voronoi diagram simulates a spatial influencing range of wetland park, it not only takes the distance between geometric centers of parks as an influencing factor, but also considers important factors of the ecosystem service value of wetland park, and the Voronoi diagram is weighted. A definition of the weighted Voronoi diagram is as follows:

$${V}_{n} ( {P}_{i} , {λ}_{i} ) = {⋂}_{j \neq i} \{ P \vert \frac{d ( P , {P}_{i} )}{{λ}_{i}} < \frac{d ( P , {P}_{j} )}{{λ}_{j}} \} , ( i = 1 , 2 , … , n ) \qquad ( 7 )$$

where, Pᵢ represents n points on a two-dimensional Euclidean space, λᵢ represents given n positive real numbers; a plane is divided into n parts, division of the plane determined by Vₙ(Pᵢ, λᵢ) is called as a point-weighted Voronoi diagram, and λᵢ is the weight data of Pᵢ.

3, Structural Equation Model

Because the ecosystem service value method can only reflect the whole value of wetland ecosystem services, it cannot accurately estimate values of different service types of ecosystems. Therefore, the structural equation model is introduced to analyze the influencing on values of different service types of ecosystems of Huangshui wetland. The structural equation model (SEM) is divided into measurement and structural models. The measurement model is composed of potential variables and observation variables, and the structural model will explain causal relationship among the potential variables. The measurement model is as follows:

X=Λ_{X}ξ+δ (8)

Y=Λ_{Y}η+ε (9)

In the expressions of (8) and (9), ξ represents an exogenous potential variable matrix, X represents a measurement variable matrix of ξ, Λ_{X} represents a measurement coefficient matrix of a relationship between the measurement variable matrix X and the exogenous potential variable matrix ξ, δ represents an equation residual matrix, η represents an endogenous potential variable matrix, Y represents a measurement variable matrix of η, Λ_{y} represents a measurement coefficient matrix of a relationship between the endogenous potential variable matrix η and Y, and ε represents another equation residual matrix. A formula of the structural model is as follows:

η=Bη+Γξ+ζ (10)

in the formula (10), ξ represents an exogenous potential variable, η represents an endogenous potential variable, B represents an endogenous potential variable coefficient matrix, Γ represents an exogenous potential variable coefficient matrix, and ζ represents residual of equation.

TABLE 2
Model observation indicators

| Potential | Observation | |
|---|---|---|
| variables | variables | Implication |
| Cultural | X₁₁ | are you willing to pay for leisure and |
| services | | entertainment services in the nearby |
| (cult) | | wetland park? |
| | X₁₂ | are you willing to pay for religious and |
| | | spiritual aesthetic services |
| | | in the nearby wetland park? |
| | X₁₃ | are you willing to pay for the existence |
| | | value of the nearby wetland park? |
| | X₁₄ | are you willing to pay for the heritage |
| | | value of the nearby wetland park? |
| | X₁₅ | are you willing to pay for the scientific |
| | | research value of the nearby wetland park? |
| | X₁₆ | are you willing to pay for the cultural |
| | | and educational value of the |
| | | nearby wetland park? |
| Adjustment | X₂₁ | are you willing to pay for the improvement |
| services | | of air purification in |
| (adju) | | the nearby wetland park? |
| | X₂₂ | are you willing to pay for the service of |
| | | releasing more oxygen in |
| | | the nearby wetland park? |
| | X₂₃ | are you willing to pay for the enhanced |
| | | temperature regulation of |
| | | the nearby wetland park? |
| | X₂₄ | are you willing to pay for the enhancement |
| | | of water purification |
| | | in the nearby wetland park? |
| | X₂₅ | are you willing to pay for the service of |
| | | absorbing more carbon dioxide |
| | | in the nearby wetland park? |
| | X₂₆ | are you willing to pay for the surface |
| | | water supply of the nearby |
| | | wetland park? |
| | X₂₇ | are you willing to pay for the degradation |
| | | of pollutants in the nearby |
| | | wetland park? |
| Supply | X₃₁ | are you willing to pay for the supply of |
| services | | Typha orientalis Presl seeds to the |
| (supp) | | nearest wetland park? |
| | X₃₂ | are you willing to pay for the scenery |
| | | in the nearby wetland park? |
| | X₃₃ | are you willing to pay for the fish and |
| | | aquatic products provided by |
| | | the nearby wetland park? |
| | X₃₄ | are you willing to pay for reed seeds |
| | | in the nearby wetland park? |
| | X₃₅ | are you willing to pay for providing |
| | | fresh water resources for the nearby |
| | | wetland park? |
| | X₃₆ | are you willing to pay for the greening |
| | | water service of the nearby |
| | | wetland park? |
| | X₃₇ | are you willing to pay for firewood and |
| | | construction timber for the |
| | | nearby wetland park? |
| Support | X₄₁ | are you willing to pay for the bank |
| services | | protection and disaster prevention services |
| (supt) | | provided by the nearest wetland park? |
| | X₄₂ | are you willing to pay for the plant |
| | | diversity protection services |
| | | provided by the nearby wetland park? |
| | X₄₃ | are you willing to pay for the animal |
| | | diversity protection services |
| | | provided by the nearby wetland park? |
| | X₄₄ | are you willing to pay for the fixed |
| | | nutrient services provided by |
| | | the nearby wetland park? |
| | X₄₅ | are you willing to pay for the service |
| | | of reducing soil erosion in |
| | | the nearby wetland park? |

4, Data Source and Processing

2.4.1 Questionnaire Data and Network Data

Questionnaires can be distributed to residents of residential neighbourhoods around wetland parks. For example, a total of 460 questionnaires were sent out three times, 115 questionnaires were collected from Haihu, Huoshaogou, Beichuan and Ninghu respectively, and 20 invalid questionnaires were excluded, with an effective recovery rate of 95.65%.

Specific remote sensing data came from the geospatial data cloud website and Ovi interactive map platform. The specific housing price data came from the website of Xining housing administration bureau, which provides the specific information of housing price in Xining in 2020. The distances of housing to the nearest middle schools (the first seven middle schools in the city), the hospital (the third-class hospital in Xining), the city center (represented by Xining Municipal Government) as well as the four wetland parks are calculated by ArcGIS™ software (Table 3). The validity of the data was identified, and the data of 19 housing samples with large errors were removed.

TABLE 3
Statistics of housing characteristic variables

| | | Mean | Standard | Max- | Min- |
|---|---|---|---|---|---|
| | Variables | value | deviation | imum | imum |
| Location | distance from | 7.493 | 12096 | 107.003 | 0.154 |
| charac- | Haihu | | | | |
| teristic | wetland park | | | | |
| of | (km) | | | | |
| neigh- | distance from | 8.396 | 12049 | 104.567 | 0.057 |
| bourhood | Beichuan | | | | |
| | wetland park | | | | |
| | (km) | | | | |
| | distance from | 6.835 | 12039 | 105.768 | 0.111 |
| | Huoshaogou | | | | |
| | wetland park | | | | |
| | (km) | | | | |
| | distance from | 13.478 | 11343 | 101.076 | 0.057 |
| | Ninghu | | | | |
| | wetland park | | | | |
| | (km) | | | | |
| Neigh- | distance from | 4.525 | 11533 | 95.819 | 0.090 |
| borhood | nearest | | | | |
| charac- | hospital (km) | | | | |
| teristics | distance from | 6.447 | 11786 | 101.125 | 0.292 |
| | city center | | | | |
| | (km) | | | | |
| | distance from | 4.101 | 10729 | 91.045 | 0.085 |
| | nearest | | | | |
| | middle | | | | |
| | school (km) | | | | |
| Attribute | transaction | 0.017 | 39244.518 | 0.259 | 0.000 |
| charac- | area (km²) | | | | |
| teristics | average | 0.007 | 3773.169 | 0.030 | 0.003 |
| | transaction | | | | |
| | price (Yuan/ | | | | |
| | km²) | | | | |
| | total | 0.199 | 227194.78 | 1.300 | 0.010 |
| | construction | | | | |
| | area (km²) | | | | |
| | greening rate | 33.286 | 3.936 | 45.000 | 23.000 |
| | (%) | | | | |
| | plot ratio (%) | 3.163 | 1.565 | 7.800 | 0.430 |
| | parking ratio | 0.641 | 0.438 | 2.830 | 0.000 |
| | property | 0.987 | 0.246 | 3.000 | 0.140 |
| | management | | | | |
| | fee (Yuan/ | | | | |
| | m² · month) | | | | |

2.4.2 Data Processing

Based on the SPSS (abbreviation for statistical product service solutions) software platform, using regression analysis and OLS (Ordinary Least Squares), this embodiment makes a regression analysis of 10 factors of influencing housing price and housing prices.

In this embodiment, the hedonic pricing method is used to obtain the ecosystem service value of each wetland park, and weights are determined based on the breaking point theory, and the weighted Voronoi diagram method is used to form the weighted Voronoi diagram of ecosystem service value influencing ranges of wetland parks.

Referring to Gorsuch's viewpoint, the questionnaire followed the ratio of 5:1 between the sample size and the variables, with a total of 440 questionnaires and 20 variables. Practical survey of buyers' willingness to pay for various services in the nearby wetland parks is conducted, and the questionnaire uses the Likert five-level attitude scale. SPSS 25.0 and AMOS 21.0 then are used to test the internal consistency and confirmatory factor analysis of the measurement model and the structural model.

### 3. Research Results and Analysis

3.1, Ecosystem Service Value of Huangshui Wetland Based on Hedonic Pricing Model

For the adjusted R² (R₁²=0.477<R₂²=0.540) estimated by the two models, R₂² has a higher degree of fitting, and the linear logarithmic model is used to explain the housing price. This embodiment analyzes the influencing of plateau urban wetland on the housing price of surrounding residential neighbourhoods, and calculates the marginal willingness to pay of buyers. The results in Table 4 show that: (1) the housing price (Yuan/m²) is positively correlated with the total construction area, greening rate, plot ratio, parking ratio and property management fee, and is negatively correlated with the wetland parks, the nearest middle school distances and the transaction areas. Among the four wetland parks, the negative correlation with Haihu wetland park is the most significant, and the coefficient value is −0.175. (2) Based on the multivariate linear logarithmic regression model, the marginal willingness to pay for the nearest distance between the residential neighbourhood and the wetland park is equal to β₃, and an average estimation result of the four wetland parks is 0.120 (Yuan per square meter)/meter, that is, the buyer is willing to pay additional 0.120 Yuan/m² for the distance between the residential neighbourhood and the wetland park to be reduced by one meter. In conjunction with the average price of neighbourhood of 7434.629 Yuan/m², the marginal willingness to pay accounts for 0.002% of the total housing price. (3) The average ecosystem service value of wetlands of Huangshui national park is 151.916 Yuan/m², and the ranking of ecosystem service values is as follows: Haihu wetland park>Ninghai wetland park>Huoshaogou wetland park>Beichuan wetlands park; according to the total transaction value of real estate, the total value of Huangshui wetland reaches 336.7 million Yuan in 2020, and the values of the four wetlands are 71.0 million yuan, 62.9 million yuan, 163.2 million yuan and 33 million yuan, respectively.

TABLE 4
Regression results of hedonic pricing model

| | Linear model | | Linear logarithmic model | |
|---|---|---|---|---|
| Model | B | t | B | t |
| 1. (constant) | 3200.251 ** | 1.822 | 8.427*** | 52.368 |
| 2. Haihu wetland | −0.175* | −0.997 | −8.326 × 10⁻⁶* | −0.517 |
| park | | | | |
| 3. Beichuan | −0.149* | −1.256 | −3.080 × 10⁻⁵*** | −2.824 |
| wetland park | | | | |
| 4. Huoshaogou | 0.133* | 0.703 | 2.491 × 10⁻⁶* | 0.143 |
| 5. Ninghu | −0.86* | −3.477 | −2.140 × 10⁻⁵*** | −2.843 |
| wetland park | | | | |
| 6. nearest | 0.462* | 2.651 | 2.460 × 10⁻⁵** | 1.540 |
| hospital | | | | |
| 7. city center | −0.153* | −0.920 | −4.347 × 10⁻⁶** | −0.285 |
| 8. nearest middle | 0.132* | 0.991 | 3.529 × 10⁻⁵** | 2.887 |
| school | | | | |
| 9. transaction | −0.006* | −0.679 | −5.703 × 10⁻⁷** | −0.709 |
| area | | | | |
| 10. total | 0.001* | 0.703 | 1.558 × 10⁻⁷** | 1.143 |
| construction area | | | | |
| 11. greening ratio | 78.888* | 3.291 | 0.008*** | 3.644 |
| 12. plot ratio | 352.034** | 1.823 | 0.028** | 1.595 |
| 13. parking ratio | 742.082** | 1.164 | 0.113** | 1.943 |
| 14. property | 2965.367** | 2.495 | 0.243** | 2.234 |
| management fee | | | | |

| | |
|---|---|
| Adjusted R₁² = 0.477 | Adjusted R₂² = 0.540 |
| a. dependent variables: y***p < 0.01, *p < 0.05, *p < 0.1 | b. dependent variables: y***p < 0.01, |
| | *p < 0.05, *p < 0.1 |

3.2, Ecosystem Service Value Space of Huangshui Wetland and Distance Attenuation

Based on the hedonic pricing method, the ecosystem service value of each wetland park is obtained (Table 5). Based on the breaking point theory, the ecosystem service value of the wetland park is characterized by its centrality strength, and the weight generated by the weighted Voronoi diagram is the square root of the ecosystem service value of corresponding wetland, and thereby generating the weighted Voronoi diagram (FIG. 2) of influencing ranges of ecosystem service values of wetland parks.

TABLE 5
ecosystem service values of wetland parks

| | ecosystem service value | |
|---|---|---|
| Wetland park | (ten thousand yuan) | Weight |
| Haihu wetland park | 7100 | 84.262 |
| Beichuan wetland park | 3300 | 57.446 |
| Huoshaogou wetland park | 16320 | 127.750 |
| Ninghu wetland park | 6290 | 79.310 |

Based on ArcGIS 10.2 software, the coordinates of the geometric center of each wetland park were read out. The formula (6) was used to calculate relevant indicators of space range of ecosystem service value of each wetland park (Table 6). Combined with Table 4 and FIG. 2, it can be seen that: (1) for 110 neighbourhood samples, the average neighbourhood housing price decreases with the decrease of accessibility to the wetland park, from the highest housing price of 299,92 yuan/m² around Beichuan wetland park to 2849 yuan/m². Although the price reduction is not entirely dominated by the distance from the wetland, it still reflects the influence of wetland on housing prices in some degrees. (2) The marginal implicit price of wetland park is equal to (housing price)×(coefficient of distance from wetland park)/(distance from wetland park). The marginal implicit price is (0.175×7434.623)/7493.184*1000=173.622, as per evaluation based on average housing price and the average value of distances from wetland. That is to say, when the distance to Haihu wetland park is reduced by 1 kilometer, the housing price will increase by 173.622 yuan per square meter. By analogy, the marginal implicit prices of Beichuan, Huoshaogou and Ninghu wetland parks are 131.937 yuan/m², 144.343 yuan/m² and 157.761 yuan/m², respectively; The influencing range of ecosystem service value of Huoshaogou wetland is the largest, which may be that the neighbourhood sample data are concentrated around Huoshaogou wetland park, followed by Haihu wetland park, Ninghu wetland park and Beichuan wetland park. (3) In addition to the distance between two adjacent wetland parks, the larger the radius of the arc segment, the closer the ecosystem service values of two adjacent parks related to the arc segment, and the smaller the radius, the greater the difference between the ecosystem service values of two adjacent wetland parks related to the arc segment.

TABLE 6
Relevant indicators of space distribution range

| | Circle center | Radius of |
|---|---|---|
| | of arc segment | arc segment (m) |
| Wetland park | (decimal) | D |
| Haihu → Huoshaogou | (36.665, 101.684) | 3350.827267 |
| Beichuan → Ninghu | (36.853, 101, 628) | 28654.01 |
| Beichuan → Haihu | (36.612, 101.818) | 9719.394139 |
| Beichuan→Huoshaogou | (36.718, 101.774) | 4263.933449 |
| Ninghu→Huoshaogou | (36.520, 101.990) | 16533.21627 |
| Ninghu→Haihu | (35.883, 103.332) | 158684.3351 |

FIG. 2 shows the spatial distribution of service values of ecosystems of the Huangshui wetland.

### 4. Discussion

4.1, Comparison of Different Value Evaluation Methods

Wetland ecosystem service evaluation methods include direct evaluation and indirect evaluation. Compared with the traditional evaluation method, the hedonic pricing method is easy to obtain the evaluation data and can quickly get the results, and it uses real data to simulate the market and thus can avoid the interference of subjective consciousness. Zhang Yanchun et al. studied the ecosystem service value evaluation of Huangshui wetland by using an intermediate material transformation method (market value method, carbon tax method, shadow engineering method, etc.), and calculated that the ecosystem service value of Huangshui national wetland park in 2020 was 618 million yuan. By way of the present research, the ecosystem service value of the Huangshui wetland in 2020 was calculated to be 336 million yuan. The reasons for the difference between the two are as follows: (1) the former is the wetland value under ideal conditions, while the latter is the value recognized/admitted by the market; (2) the latter is based on the total transaction volume of real estate in 2020, and there are still many housing properties have not yet been sold. The above two methods have their own advantages and disadvantages: the former can calculate values of various items of wetland ecosystems clearly, but it needs the support of multi-source data; the latter needs relatively simple data, but it cannot calculate the value of each item.

In the spatial distribution of ecosystem services, Zhang Yanchun et al. studied the spatial distribution pattern of wetland ecosystem service value based on the breaking point model through GIS spatial method. When exploring a radiation range, it takes the center of a wetland park as a circle center, takes the action radius of ecosystem service of the wetland park as a radiation radius, and radiates around; although all kinds of services are visualized, the divergence process is not homogeneous diffusion under physical conditions, and thus there will not be a spatial distribution pattern that starts from the circle center and diverges into a perfect circle with a fixed radius. In this embodiment, it combines the breaking point theory with the weighted spatial Voronoi diagram model. After the ecosystem service value of each wetland park is obtained, the weight is determined based on the urban breaking point theory, the square roots of the ecosystem service values of the four wetland parks in the research area are taken as expansion speeds, the geometric centers of the four wetlands are taken as growth cores, and the grid algorithm of Euclidean distance is employed, the weighted Voronoi diagram of the ecosystem service value influencing ranges of the wetland parks is formed by GIS. Because of the use of weights, the service value diffusion process of the present method is not a fixed radius diffusion. The ecosystem service ranges of the four wetland parks are visualized in one map at one time, and the influencing boundaries are clear.

4.2, Influencing Factors of Ecosystem Service Values of Huangshui Wetland

The evaluation method based on hedonic pricing model cannot define values of different types of ecosystems. Therefore, this embodiment constructs a structural equation model of wetland ecosystem service satisfaction, and explores main influencing factors of wetland ecosystem services based on the result of questionnaire survey. The result showed that a proportion of men to women in the gender survey was 0.93, and proportions of men and women are roughly the same. The respondents aged 19-60 accounted for 93.6%, indicating that the buyers are generally middle-aged, most of them have high school education, and most of them have an income of 3000-5000 yuan per month. The Cronbach's coefficients and KMO (abbreviation for Kaiser-Meyer-Olkin) values of potential variables such as supply service, adjustment service, cultural service and support service are all greater than 0.6, indicating that the data pass the reliability and validity test and meet the needs of structural equation modeling (Table 7).

TABLE 7
Statistical test of reliability and validity of sample data

| | Number of | Cronbach's | |
|---|---|---|---|
| Potential variables | measurable variables | coefficient α | KMO |
| Cultural service | 6 | 0.643 | 0.714 |
| Adjustment service | 7 | 0.682 | 0.727 |
| Supply service | 7 | 0.679 | 0.73 |
| Support service | 5 | 0.627 | 0.64 |

This embodiment uses absolute fitting indexes: CMIN/DF, AGFI, GFI, a relative fitting index: NFI, and substitutive indexes: CFI, RMSEA, a total of six indexes are used to judge the fitting effect of the structural equation model of wetland ecosystem service value satisfaction. Initial fitting effects of the model are shown in Table 8.

TABLE 8
Test of fitting effect of structural equation model

| Model fit | | Fitting | | Model fit structure |
|---|---|---|---|---|
| index | Meaning of model fitting index | standard | Result | judgement estimate |
| CMIN/DF | Chi-square/degree of freedom ratio | 2-5 | 2.926 | Yes |
| RMSEA | Root mean square error of approximation | ≤0.1 | 0.082 | Yes |
| GFI | Goodness of fit index | ≥0.85 | 0.845 | Yes |
| AGFI | Adjusted goodness-of-fit index | ≥0.80 | 0.802 | Yes |
| NFI | Normed fit index | ≥0.80 | 0.884 | Yes |
| CFI | Comparative fit index | ≥0.90 | 0.921 | Yes |

The test results showed that the Chi-square/degree of freedom ratio (CMIN/DF) of the model was 2.926, indicating that the fitting degree of model was good; the RMSEA value was 0.082 and less than 0.1, and the GFI value was 0.845 and greater than 0.85, indicating the model is good; the relative fitting index CFI is greater than 0.90, and the NFI value is 0.882, which is within the acceptable range, and the fitting effect of model is good.

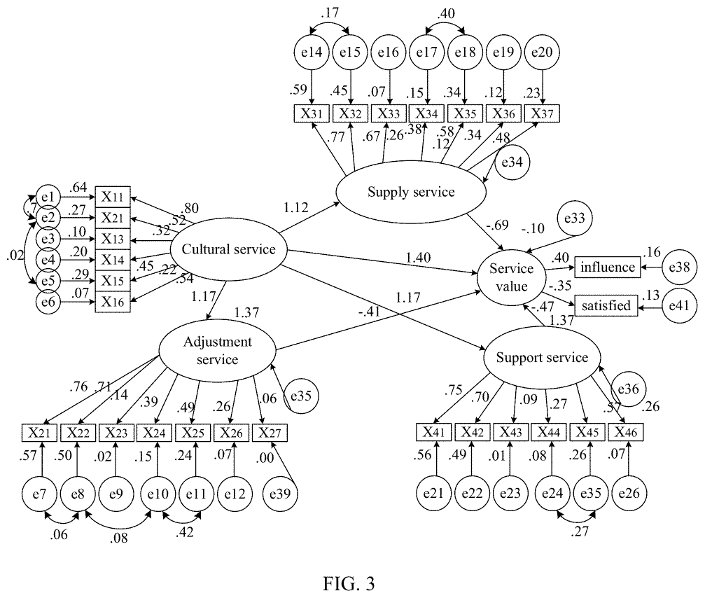

FIG. 3 is a path diagram of standardized coefficients of model. After model testing, the standard path coefficients show that: (1) the cultural service has the greatest impact/influence on the service value of wetland ecosystem, its standard path coefficient is 1.404>0, P<0.001, with high significance, and the two have a high positive correlation, indicating that one percentage point of cultural service will directly increase the ecosystem service value by 1.404 percentage points, which shows that the better the cultural service is, the more beneficial it is to enhance the service value of wetland ecosystem; (2) among the potential variables of affecting cultural service, X₁₁ (leisure and entertainment services provided by wetland park) has the greatest influencing on cultural service, with a standard path coefficient of 0.80, indicating that one percentage point of leisure and entertainment of wetland park will increase cultural service by 0.798 percentage points; (3) among the four ecosystem services, the causal effect between the cultural service and the adjustment service is the most significant. When the cultural service is increased by one percentage point, the adjustment service will be increased by 1.171 percentage points and is significant. See Table 9 for path coefficient estimation results.

TABLE 9
Path coefficient estimation results

| | Non | | | | |
|---|---|---|---|---|---|
| | standardized | | | | Standardized |
| | path | | | | path |
| | coefficient | | | | coefficient |
| | estimates | S.E. | C.R. | P | estimates |
| Adjustment service | 0.874 | 0.043 | 20.559 | *** | 1.171 |
| ←cultural service | | | | | |
| Support | 0.862 | 0.044 | 19.786 | *** | 1.169 |
| service←cultural | | | | | |
| service | | | | | |
| Supply | 0.815 | 0.034 | 24.122 | *** | 1.116 |
| servicer←cultural | | | | | |
| service | | | | | |
| Service value | 0.628 | 0.324 | 1.941 | *** | 1.404 |
| of ecosystem | | | | | |
| ←cultural service | | | | | |
| Service value | −0.245 | 0.118 | −2.08 | ** | −0.408 |
| of ecosystem | | | | | |
| ←adjustment | | | | | |
| service | | | | | |
| Service value | −0.286 | 0.119 | −2.397 | ** | −0.471 |
| of ecosystem | | | | | |
| ←support service | | | | | |
| Service value | −0.424 | 0.180 | −2.354 | ** | −0.692 |
| of ecosystem | | | | | |
| ←supply service | | | | | |
| X₁₁ ← cultural | 1.000 | | | | 0.798 |
| service | | | | | |
| X₂₁ ← adjustment | 1.000 | | | | 0.755 |
| service | | | | | |
| X₃₁ ← supply | 1.000 | | | | 0.771 |
| service | | | | | |
| X₄₁ ← support | 1.000 | | | | 0.746 |
| service | | | | | |

Notes:
*** P < 0.01,
** P < 0.05 (two-tailed test); N = 440.

### 5. Conclusion

By collecting housing characteristics and price data of Xining city, based on ArcGIS 10.2, EMVI 5.3 and SPSS 25 software platforms, the embodiment of the invention quantitatively characterizes the ecosystem service values, the spatial influencing ranges and the influencing factors of the urban wetland parks through using the hedonic pricing model, the breaking point model and the structural equation model. The main conclusions are as follows.

(1) The ecosystem service value of Huangshui wetland in 2020 is about 336.7 million yuan calculated by the hedonic pricing model, and the proportion of service values of wetland ecosystems to the total value of real estate is 2.04%, and thus the existence of Huangshui wetland increases the value of surrounding real estate.

(2) The spatial influencing ranges of the wetland services are in the order of Huoshaogou>Haihu wetland>Ninghu wetland>Beichuan wetland, and the marginal willingness to pay of the buyers for wetland is 0.12 (yuan/m²) m⁻¹.

(3) Buyers have the greatest willingness to pay for the cultural service of wetland, which is mainly reflected in the leisure and entertainment services provided by the wetlands.

The above is only preferred specific embodiments of the invention, but the scope of protection of the invention is not limited to this. Any change or substitution that can be easily conceived by those skilled in the art within the technical scope disclosed by the invention shall be included in the scope of protection of the invention. Therefore, the scope of protection of the invention should be determined by the scope of protection of the appended claims.

What is claimed is:

1. A method for estimating service value spaces of wetland ecosystems, comprising:
step 1, calculating service values of wetland ecosystems through a hedonic pricing method; and
step 2, calculating, based on the service values of the wetland ecosystems, a spatial distribution state of the service values of the wetland ecosystems through a breaking point theory and a weighted Voronoi diagram model, and outputting the spatial distribution state; and
the method further comprises: applying the spatial distribution state as a basis for wetland management.

2. The method as claimed in claim 1, further comprising:
step 3, calculating, based on the service values of the wetland ecosystems, influencing factors of the service values of the wetland ecosystems through a structural equation model, and outputting the influencing factors, wherein the influencing factors are applied as a basis for wetland management.

3. The method as claimed in claim 1, wherein the step 1 comprises:
step 11, categorizing, based on distances between neighbourhoods in a designated area and the wetland ecosystems, the neighbourhoods into the wetland ecosystems, to establish a correspondence between the neighbourhoods and the wetland ecosystems;
step 12, multiplying an average transaction price of neighbourhoods of each of the wetland ecosystems by a transaction house quantity of each of the neighbourhoods of each of the wetland ecosystems, to obtain a transaction value of each of the neighbourhoods;
step 13, summing the transaction values of the neighbourhoods of each of the wetland ecosystems, to generate a transaction value of each of the wetland ecosystems;
step 14, generating a wetland coefficient for distance to wetland park of each of the neighbourhoods through the hedonic pricing method;
step 15, multiplying a total housing price of each of the wetland ecosystems by the wetland coefficient for distance to wetland park of each of the neighbourhoods and then being divided by a distance to wetland park of each of the neighbourhoods, to generate a marginal implicit price of each of the wetland ecosystems;
step 16, obtaining an average marginal implicit price of the wetland ecosystems based on the marginal implicit price of each of the wetland ecosystems;
step 17, dividing the average marginal implicit price of the wetland ecosystems by an average transaction price of the neighbourhoods of the wetland ecosystems, to obtain a marginal willingness to pay; and
step 18, multiplying the generated transaction value of each of the ecosystems by the marginal willingness to pay, to generate the service values of each of wetland ecosystems.

4. The method as claimed in claim 3, wherein the step 14 comprises:
In(Pᵢ)=β₀+β₁Sᵢ+β₂Nᵢ+β₃Qᵢ+εᵢ
where, Pᵢ represents an average unit price of a i-th neighbourhood; Sᵢ represents a structural attribute characteristic vector matrix of housing, including transaction area, total construction area, greening rate, plot ratio, parking ratio, and property management fee of housing; Nᵢ represents a neighborhood attribute characteristic vector matrix of housing, including distances of housing to its nearest secondary school, hospital and city center; Qᵢ is a model introduced virtual variable and represents a distance to wetland park of the i-th neighbourhood; εᵢ is an error term, and βₖ represents a matrix of wetland coefficient for distance to wetland park of each of the neighbourhoods, and k=0, 1, 2, 3.

5. The method as claimed in claim 1, wherein the step 2 comprises:
step 21, according to the breaking point theory, generating, based on the service values of the wetland ecosystems, weight data of each of the neighbourhoods with respect to the wetland ecosystem corresponding thereto through the weighted Voronoi diagram model;
step 22, generating a wetland center of each of the wetland ecosystems through an ArcGIS software; and
step 23, generating, based on the wetland center and the weight data, a weighted Voronoi diagram of influencing ranges of the service values of the wetland ecosystems through a Thiessen polygon tool of the ArcGIS software, as the spatial distribution state of the service values of the wetland ecosystems.

6. The method as claimed in claim 5, wherein the step 23 comprises:
$${V}_{n} ( {P}_{i} , {λ}_{i} ) = {⋂}_{j \neq i} \{ P \vert \frac{d ( P , {P}_{i} )}{{λ}_{i}} < \frac{d ( P , {P}_{j} )}{{λ}_{j}} \} , ( i = 1 , 2 , … , n )$$
where, Pᵢ, Pᵢ each represent n points on a two-dimensional Euclidean space, λᵢ, λⱼ each represent given n positive real numbers, when a plane is divided into n parts, division of the plane determined by Vₙ(Pᵢ, λᵢ) is called as a point-weighted Voronoi diagram, λᵢ, and λⱼ are the weight data of Pᵢ, Pⱼ respectively.

7. The method as claimed in claim 2, wherein the step 3 comprises:
step 31, establishing the structural equation model through an AMOS software based on potential variables of service types provided by the wetland ecosystems, to obtain standardized path coefficients of the service types;
step 32, dividing the standardized path coefficients of the service types by the sum of the standardized path coefficients of the service types, to generate an influencing coefficient of standardized path of each of services; and
step 33, multiplying the service value of each of the wetland ecosystems by the influencing coefficient of standardized path of each of services, to obtain a service value of each of the services.

8. The method as claimed in claim 7, wherein the service types comprise: supply service, adjustment service, cultural service, and support service.

9. The method as claimed in claim 7, wherein the structural equation model specifically is as follows:
X=Λₓξ+δ
Y=Λ_{y}η+ε
where, ξ represents an exogenous potential variable matrix, X represents a measurement variable matrix of ξ, Λₓ represents a measurement coefficient matrix of a relationship between the measurement variable matrix X and the exogenous potential variable matrix ξ, δ represents an equation residual matrix, Y represents a measurement variable matrix of η, Λ_{y} represents a measurement coefficient matrix of a relationship between an endogenous potential variable matrix η and Y, and ε represents another equation residual matrix; and
a formula of a structural model of the structural equation model is as follows:
η=Bη+Γξ+ζ
where, B represents an endogenous potential variable coefficient matrix, Γ represents an exogenous potential variable coefficient matrix, and ζ represents residual of equation.
